(19) United States
(12) Patent Application Publication
(10) Pub. No.: US 2018/0120193 A1
(43) Pub. Date: May 3, 2018

(54) SYSTEM AND METHOD FOR LEAKAGE DETECTION USING A DIRECTIONAL CONTROL VALVE

(71) Applicant: Nexmatix LLC, St. Louis, MO (US)

(72) Inventors: Dennis T. Mell, Farmington, MO (US); Ellen R. Mell, Farmington, MO (US); Michael Goldfarb, Franklin, TN (US)

(73) Assignee: Nexmatix LLC, St. Louis, MO (US)

(21) Appl. No.: 15/566,263

(22) PCT Filed: Apr. 19, 2016
(86) PCT No.: PCT/US16/28301

§ 371 Date: Oct. 13, 2017

Related U.S. Application Data
(60) Provisional application No. 62/149,958, filed on Apr. 20, 2015.

(51) Int. Cl. G01M 3/26; F16K 37/00

(52) U.S. Cl. CPC G01M 3/26; F16K 11/0712; F16K 37/005

(57) ABSTRACT

This application describes apparatuses, systems, and methods that combines specific configurations of a pneumatic actuation system together with a pressure measurement device to allow for measurement of pressure inside isolated subsystems within the system to thereby provide detection of leaks within the system. In certain exemplary embodiments, the apparatus comprises a directional control valve that employs at least one port connectivity configuration that creates at least one isolated fluid subsystem within the overall system. When the valve is in this isolated subsystem configuration, a given mass of fluid (i.e., compressed gas) can neither enter nor leave the subsystem. The leak detection method consists of momentarily placing the valve in this isolated subsystem configuration when switching between standard configurations, and measuring pressure with at least one pressure sensor in the isolated fluid subsystem while in this configuration, where loss of pressure in this configuration indicates existence of a leak.

### CROSS REFERENCE TO RELATED APPLICATION

This application claims priority to and the benefit of U.S. Provisional Patent Application No. 62/149958 that was filed on Apr. 20, 2015, the entirety of which application is hereby incorporated by reference.

### STATEMENT REGARDING FEDERALLY SPONSORED RESEARCH OR DEVELOPMENT

Not applicable.

### SEQUENCE LISTING, TABLE OR COMPUTER PROGRAM ON COMPACT DISC

Not applicable.

### FIELD OF INVENTION

This invention relates generally to directional control valves and particularly to pneumatic control valves and systems that include leak detection.

### BACKGROUND OF THE INVENTION

Leakage of compressed air in an industrial pneumatic system can be a significant source of energy loss. The compressed air conduits that comprise pneumatic actuation systems in such settings are often complex, tortuous, and comprise a large number of connections between pneumatic components, all of which are potential sites of air leakage. Further, leakage can be difficult to detect in an industrial environment, which is typically noisy, particularly because compressed air is not visible and has no smell. As such, it is desirable to have a system that can identify the presence of compressed air leaks, so that such leaks can be subsequently eliminated. Additionally, because new leaks can appear at any time, it is desirable to have a system that monitors and detects leaks either continuously, or at regular, frequent intervals, without interruption of the normal industrial purpose or functioning of the pneumatic system. Further, it is desirable to do so without additional apparatus that would add to the cost or complexity of a typical pneumatic actuation system.

### SUMMARY OF THE INVENTION

The present invention meets the need in the art and is directed to systems, methods, and an improved valve for detecting leaks in a pneumatic system, particularly a pneumatic system that entails at least a control valve. An exemplary such control valve is a directional control valve that can be used to control the position of a pneumatic actuator. A “standard” two-position directional-control valve is defined for purposes of this application as one that selectively connects a minimum of four fluid ports in at least two port connectivity configurations, and wherein the four fluid ports consist generally of first and second inlet ports and first and second outlet ports. In one common pneumatic system the first and second inlet ports are typically connected respectively to supply pressure and an exhaust pressure, while the first and second outlet ports are typically connected to the first and second ports of one or more two-port pneumatic components, an exemplary example of such component being a double-acting pneumatic actuator. As such, the minimum of four ports associated with a directional control valve are typically supply S, exhaust E, a first outlet A, and a second outlet B, respectively.

The two valve positions and corresponding port connectivity of a standard two-position directional-control valve 1a are shown schematically in FIG. 1. Note that though the typical prior art valve is discussed in terms of four operative ports, in actuality the typical valve comprises at least these four distinct fluid ports. As shown in FIG. 1 in certain embodiments, prior art valve 1a may have two exhaust ports, a first exhaust port E₁ and a second exhaust port E₂, both of which are characterized by the same (typically atmospheric) fluid potential. Thus, in the schematic diagram of FIG. 1 one of the exhaust ports E₁, E₂ in the preferred 5-port embodiment valve 1a is not used in a given valve position. Despite this, the 5-port embodiment valve 1a is a preferred embodiment because a 5-port configuration is a standard, preferred. configuration in the pneumatic industry, and as such, a 5-port embodiment of the valve maintains a standard connectivity with existing pneumatic apparatus (e.g., valve manifolds). As such, illustrations of the valve embodiment and functionality herein are provided in the context of a 5-port embodiment valve. It should be clear to one having ordinary skill in the art that a 4-port embodiment is merely a simplification of the 5-port version, because elimination of the fifth port (which is the second exhaust port) yields a 4-port embodiment of the inventive valve.

As can further be seen from FIG. 1, a standard two-position directional-control valve is typically configured into either a first position P1 or a second position P2. The first valve position P1 provides a port connectivity configuration in which the first inlet port (or “supply port”) provides supply pressure and is connected to the first outlet port, and the second inlet port (or “exhaust port”) is connected to the second outlet port. The second valve position P2 provides a port connectivity configuration in which the supply port is connected to the second outlet port, and the exhaust port is connected to the first outlet port.

As shown in FIG. 2A, a directional-control valve 1b may also employ a third position, which corresponds to a third port connectivity configuration. This application describes an embodiment method for the detection of leaks in a compressible gas fluid-powered system that employs a directional control valve with a third port connectivity configuration in which the third-position port connectivity creates within the valve and component(s) system at least one isolated fluid subsystem. Two exemplary third-position port connectivity configurations for this purpose are shown in the schematics of FIG. 2A and FIG. 2B.

In the configuration shown in FIG. 2A, the third (i.e., center) position of valve 1b provides exclusive fluid connectivity between the first and second outlet ports A, B, while maintaining the supply and exhaust ports S, E in fluid isolation. In the case where the first outlet port is connected to a first component chamber (e.g. the chamber on one side of a piston in a double-acting actuator) and the second outlet port is connected to a second component chamber (e.g., the chamber on the other side of the piston in the actuator), the P3 configuration of port connectivity shown in FIG. 2A can be referred to as the “equilibration configuration” of the directional control valve. While in this equilibration configuration, valve 1b effectively isolates the mass of fluid (i.e., compressed air) within the two chambers of the actuator and the actuator supply lines (feeding the two chambers) from all other compressed air in the pneumatic actuation system, such that fluid mass within the actuator and actuator supply lines can neither flow into nor out of this control volume. The volume of isolated fluid can be considered to be contained within an “isolated fluid subsystem.”

The fluid in the isolated fluid subsystem therefore consists of the volume of compressed air generally confined within the actuator's two chambers, the actuator supply lines, and the flow channels within the directional control valve connecting the two actuator supply lines. Under normal operating conditions, no mass should enter or leave the isolated fluid subsystem while the valve is in the equilibrium configuration (the configuration at which the pressure in the two actuator chambers is moving toward and maintaining equilibrium). This type of system (i.e., a fluid system with constant fluid mass) generally referred to as a closed thermodynamic system. Because this is a closed thermodynamic system, the mass of the gas (i.e., compressed air) in the closed system can be related algebraically to the pressure of the gas via the constitutive behavior of the gas. The most commonly assumed constitutive behavior is the ideal gas law. Assuming the gas can be described by the ideal gas law, and assuming a constant volume and isothermal behavior (i.e., constant gas temperature), the pressure in the isolated fluid subsystem will be directly proportional to the mass of compressed air in the isolated fluid subsystem. As such, while the valve is maintained in the equilibrium configuration, changes in fluid mass within the isolated fluid subsystem (e.g., due to fluid leakage) can be detected from changes in measured pressure, which is the basis for the embodiment inventions described here.

In one embodiment, the invention is directed to a method for detecting leaks in a pneumatic system that includes a 3-position directional control valve. The valve comprises a supply port S, a first exhaust port E or E₁, a first outlet port A, and a second outlet port B. Per the discussion above, the valve may include a second exhaust port E₂. The valve is fluidly connected to one or more pneumatic components that cumulatively provide for a first component chamber fluidly served by a first component port and a second component chamber fluidly served by a second component port. As noted, a double-acting actuator (a/k/a double-acting cylinder) for example is a single device having a first component chamber fluidly served by a first component port and a second component chamber fluidly served by a second component port. Thus, for sake of simplicity, the invention will be described in the context of a double-acting actuator. This is not intended to be limiting. The first component port and the second component port may be disposed on separate components. In the exemplary, double-acting actuator system, the first actuator port is the first component port fluidly connected to the first valve outlet port and the second actuator port is the second component port fluidly connected to the second valve outlet port.

The method comprises configuring the valve such that the valve establishes an exclusive intra-valve fluid flow path between the first and second valve outlet ports and also respective isolation of the first and second valve inlet ports (the supply and exhaust ports), such that the valve creates an isolated fluid subsystem that includes: the first outlet port of the valve, the intra-valve fluid flow path between the first outlet port and the second outlet port, the second outlet port of the valve, the fluid connection between the first outlet port and the first component port, the first component chamber fluidly served by the first component port, the fluid connection between the second outlet port and the second component port and the second component chamber fluidly served by the second component port. In terms of a double-acting actuator, the isolated fluid subsystem would include the actuator; the fluid connection between the first actuator port and the first valve outlet port; the fluid connection between the second actuator port and the second valve outlet port; and the intra-valve fluid flow path between the first and second valve outlet ports. The method further comprises sensing (measuring) the pressure within the isolated fluid subsystem. The sensed pressure can be compared to a value deemed to represent an acceptable system pressure (i.e., a pressure at which no leak exists in the isolated fluid subsystem). The pressure in the isolated system may be sensed over one or more time intervals so as to check whether any rate of pressure drop exceeds any acceptable rate of pressure decay for the system.

Thus, this application describes a means of detecting leaks in a compressed gas fluid powered system by employing the combination of a directional control valve that utilizes a specific port connectivity configuration to create an isolated fluid subsystem, in combination with a pressure sensor located in the isolated fluid subsystem, to enable detection of leaks within the isolated fluid subsystem. The approach is specifically intended to provide a minimalist, low-cost method for detection of fluid leaks in the isolated fluid subsystem within the valve and actuator.

Further, because the equilibrium configuration created by the third-position port connectivity shown in FIG. 2A creates a single isolated fluid subsystem, a single pressure sensing element, as indicated in FIG. 3, can be employed to measure the pressure in this isolated fluid subsystem. In a preferred embodiment, the single pressure sensing element is located within the directional control valve and the measurement of pressure is thus taken there. In a preferred embodiment, a single controller coordinates valve configuration and pressure measurement based upon the processing of sensed pressure, such that the valve configuration and pressure measurement can be appropriately coordinated, as per the leak detection method.

In another preferred embodiment, the invention is directed to a pneumatic system that comprises a directional control valve fluidly connected to a first component port and a second component port (which again for simplicity of explanation can be described as the first and second ports of a double-acting pneumatic actuator). The directional control valve includes a supply port, a first exhaust port, a first valve outlet port, and a second valve outlet port. The valve may include a second exhaust port. The supply port connects to a fluid supply and the exhaust port connects to exhaust. The double-acting pneumatic actuator includes a first component (actuator) port and a second component (actuator) port. A fluid connection connects the first valve outlet port with the first actuator port and a fluid connection connects the second valve outlet port to the second actuator port. The directional control valve is capable of being configured into a first configuration, a second configuration and a third configuration whereby in the first configuration the valve establishes an exclusive connection of the supply port with the first valve outlet port, and the simultaneous exclusive connection of the exhaust port with the second valve outlet port. In the second configuration the valve establishes the exclusive connection of the supply port with the second valve outlet port, and the simultaneous exclusive connection of the exhaust port with the first valve outlet port. In the third configuration the valve establishes an exclusive intra-valve fluid flow path between the first and second valve outlet ports and establishes respective isolation of the supply and exhaust ports, such that the valve creates an isolated fluid subsystem that includes: the actuator; the fluid connection between the first actuator port and the first valve outlet port; the fluid connection between the second actuator port and the second valve outlet port; and the intra-valve fluid flow path between the first and second valve outlet ports. The system includes at least one pressure sensor configured to measure pressure within the isolated fluid subsystem established by the third configuration of the valve. In a preferred embodiment system the at least one pressure sensor is a single pressure sensor located within the directional control valve.

In another preferred embodiment the invention is directed to a directional control valve that comprises a supply port, a first exhaust port, a first outlet port, and a second outlet port. The valve may include a second exhaust port. The directional control valve is capable of being configured into a first configuration, a second configuration and a third configuration whereby in the first configuration the valve establishes an exclusive connection of the supply port with the first valve outlet port, and the simultaneous exclusive connection of the exhaust port with the second valve outlet port. In the second configuration the valve establishes the exclusive connection of the supply port with the second valve outlet port, and the simultaneous exclusive connection of the exhaust port with the first valve outlet port. In the third configuration the valve establishes an exclusive intra-valve fluid flow path between the first and second valve outlet ports and establishes respective isolation of the supply and exhaust ports. The valve further includes at least one pressure sensor located within the directional control valve, more preferably in the exclusive intra-valve fluid flow path formed by the third configuration.

As described in more detail hereafter, other embodiments of the invention involve usage of a directional control valve in which the third (i.e., center) position of the valve provides for a configuration in which all ports of the valve are blocked (i.e., isolated). The configuration of this port connectivity is shown in FIG. 2B. While in this configuration, the valve effectively creates a separate isolated fluid subsystem at each outlet port. One isolated fluid subsystem includes the first outlet port of the valve, the fluid connection between the first outlet port and the first component port (e.g., a first actuator port) and the first component chamber (e.g., the first chamber of the actuator) fluidly connected to the first component port. The second isolated fluid subsystem includes the second outlet port of the valve, the fluid connection between the second outlet port and the second component port (e.g., a second actuator port) and the second component chamber (e.g., the first chamber of the actuator) fluidly connected to the second component port.

### BRIEF DESCRIPTION OF THE DRAWINGS

FIG. 1 is a schematic diagram of port connectivity for a standard 2-position, 2-way, 5-port valve.

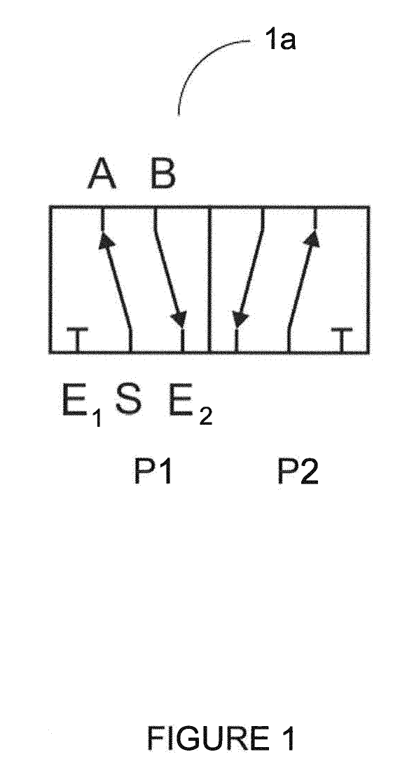

FIG. 2A is a schematic diagram depicting port connectivity for a 5-port valve utilized in the present invention in which configuring the valve in the third position results in an intra-valve fluid flow path between the first and second outlet ports A, B.

FIG. 2B is a schematic diagram of a valve depicting port connectivity for a 5-port valve utilized in the present invention in which configuring the valve in the third position results in an all-ports blocked status in the valve.

FIG. 3 is a diagrammatic view of the flow-determining cross section of an embodiment of the body and spool configuration for a 3-position, 5-port spool valve utilized in accordance with the present invention. The valve has a sensor located proximate the first outlet port A of the valve.

FIG. 4 is a diagrammatic view of the flow-determining cross section of an embodiment of the body and spool configuration for a 3-position, 5-port spool valve utilized in accordance with the present invention. The valve has a sensor located proximate the second outlet port B of the valve.

FIG. 5 is a section view of an embodiment valve (a spool valve) of the present invention showing the spool (i.e., a fluid diverter) in the first position P1, which provides for port connectivity between supply port S and first outlet port A, and between second exhaust port E2 and second outlet port B. First exhaust port E1 is not used and is fluidly isolated.

FIG. 6 is a section view of an embodiment valve of the present invention showing the spool in the second position P2, which provides port connectivity between first exhaust port E1 and first outlet port A, and between supply port S and second outlet port B, respectively. Second exhaust port E2 is not used and is fluidly isolated.

FIG. 7 is a section view of an embodiment valve of the present invention showing the spool in the third position P3, which is between spool positions P1 and P2 and provides port connectivity between first outlet port A and second outlet port B, and fluidly isolates supply port S and first and second exhaust ports E1 and E2.

FIG. 8 is a schematic diagram showing an embodiment pneumatic system according to the present invention in the context of a double-acting cylinder. The valve is shown in the first position. Setting of the valve in the first position results in pressurization of the first chamber of the cylinder. This pressurization, in turn, results in extension of the piston rod.

FIG. 9 is a schematic diagram showing the embodiment pneumatic system depicted in FIG. 8. The valve is shown in the third position when transitioning from piston rod extension to retraction. This position creates an isolated fluid subsystem comprising the first chamber of the actuator, the second chamber of the actuator, the fluid connections between the actuator and the valve and the intra-valve fluid flow path created between first outlet port A and second outlet port B.

FIG. 10 is a schematic diagram depicting the embodiment system of FIG. 8. The valve is shown in the second position. Setting of the valve in the second position results in the pressurization of the second chamber of the cylinder and effects retraction of the piston rod.

FIG. 11 is a schematic diagram showing the embodiment pneumatic system depicted in FIG. 8. The valve is shown in the third position then transitioning from piston rod retraction to extension. This position creates an isolated fluid subsystem comprising the first chamber of the actuator, the second chamber of the actuator, the fluid connections between the actuator and the valve and the intra-valve fluid flow path created between first outlet port A and second outlet port B.

FIG. 12 is a schematic diagram showing another embodiment pneumatic system according to the present invention in context of a double-acting cylinder. The valve is shown in a third (center) position in which all ports are blocked. Setting of the valve in this position results in two isolated fluid subsystems. The actuator is shown with its rod extended.

FIG. 13 is a schematic diagram showing the system of FIG. 12 in which the valve is in a first position, which provides for port connectivity between supply port S and first outlet port A, and between second exhaust port E2 and second outlet port B. First exhaust port E1 is not used and is fluidly isolated.

FIG. 14 is a schematic diagram showing the system of FIG. 12 in which the valve is in a second position, which provides for port connectivity between supply port S and second outlet port B, and between second exhaust port E1 and second outlet port A. Second outlet port E2 is not used and is fluidly isolated.

FIG. 15 is a schematic diagram showing the system of FIG. 12 in which the valve is in the third (center) position in which all ports are blocked. The actuator is shown with its rod retracted.

### DETAILED DESCRIPTION

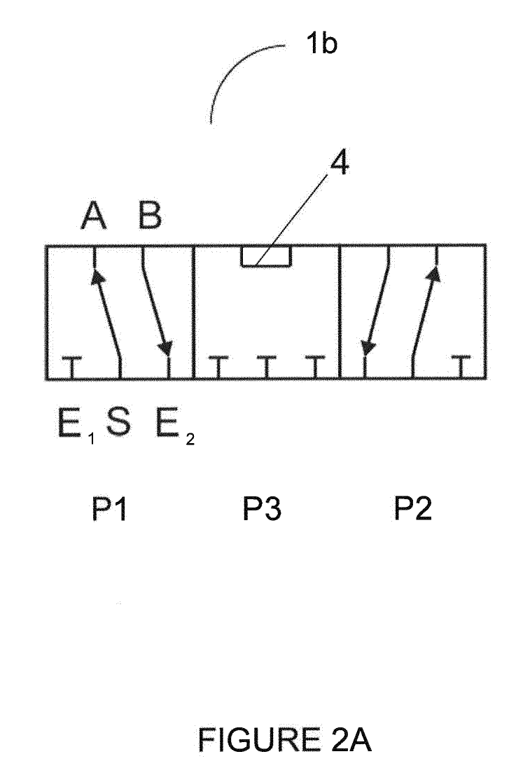

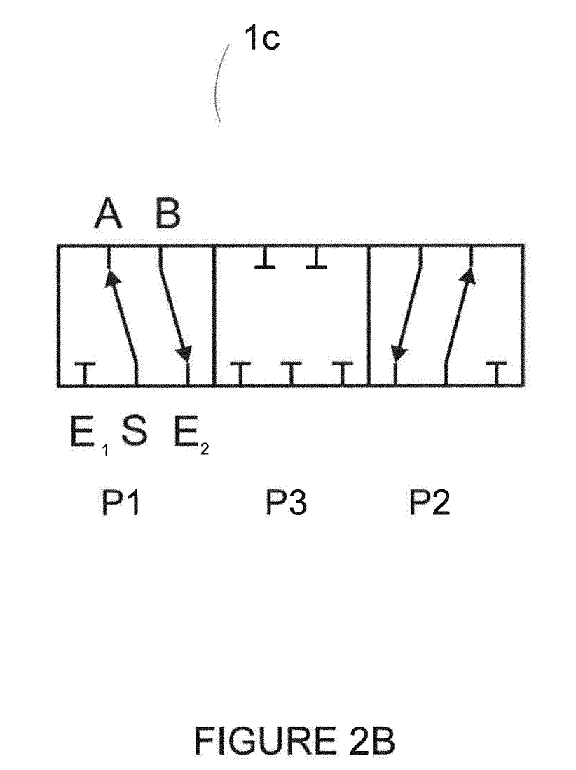

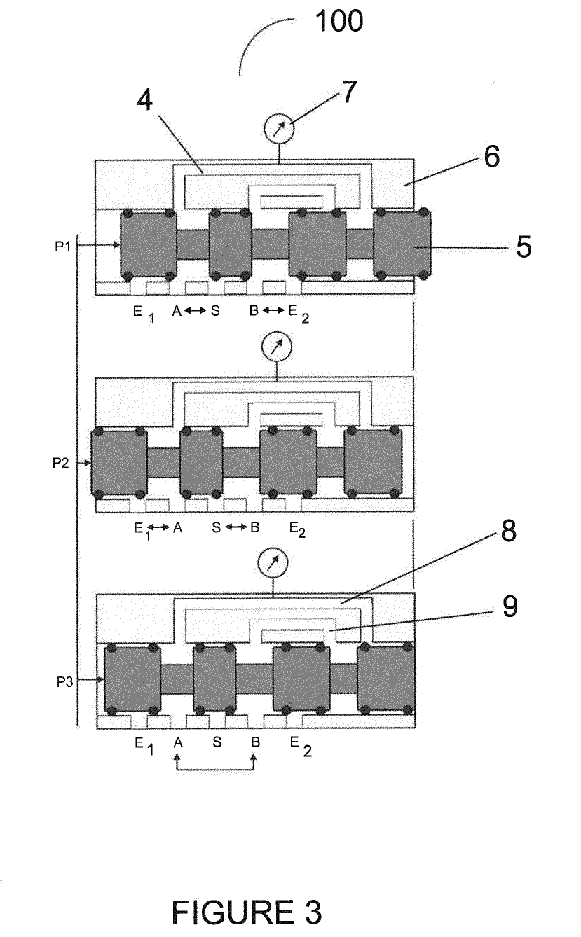

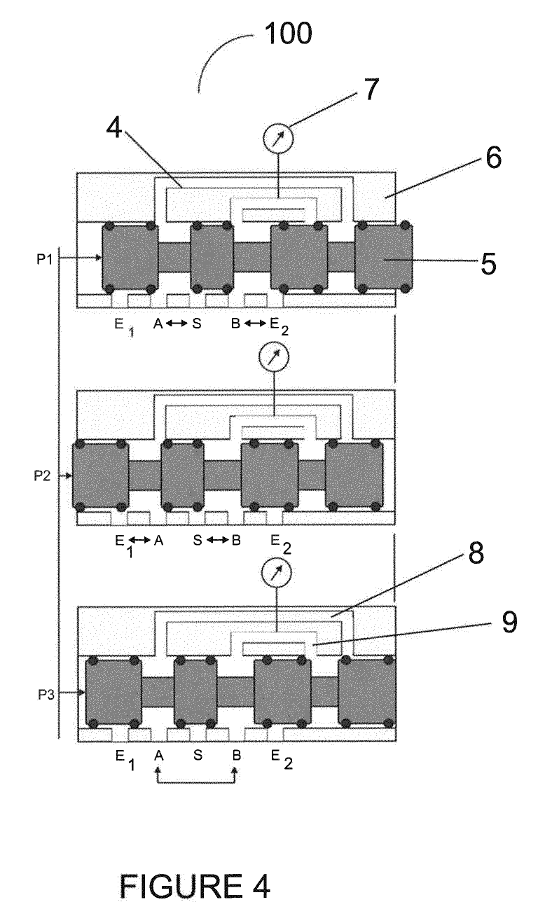

The present invention is directed to a valve, valve system, and method for detecting leaks in a pneumatic system. Diagrams of the flow determining positions of an embodiment valve 100 are depicted in FIGS. 3 and 4. These figures show a fluid diverter in the form of valve spool 5 and body 6 that provide the three-position port connectivity corresponding to the schematic of FIG. 2A and additionally show two preferred locations for a pressure sensor 7 in valve 100. When valve spool 5 is configured in the third position P3, an intra-valve fluid flow path 4 is established between the outlet ports A and B, where the intra-valve fluid flow path 4 includes a first intra-valve segment 8 and a second intra-valve segment 9. When configured in the third position P3, compressed gas can flow from outlet port A, around the valve spool, through intra-valve segment 8, around the valve spool, through intra-valve segment 9, and around the valve spool again to outlet port B (or in the opposite direction, depending on the pressure differential). In one variation, pressure sensor 7 measures the pressure in intra-valve segment 8 (FIG. 3), while in a second variation, pressure sensor 7 measures the pressure in intra-valve segment 9 (FIG. 4). In both variations, pressure sensor 7 measures the pressure in an isolated fluid subsystem comprising the intra-valve fluid flow path 4 between the outlet ports A and B when valve 100 is placed in the third position. The two variations, however, measure different pressures when the valve spool is in either the first or second positions, P1 and P2. Specifically, in the variation shown in FIG. 3, pressure sensor 7 measures the pressure at port A when valve 100 is configured in the first and second valve positions P1, P2. In the variation shown in FIG. 4, pressure sensor 7 measures the pressure at port B when valve 100 is configured in the first and second valve positions P1, P2.

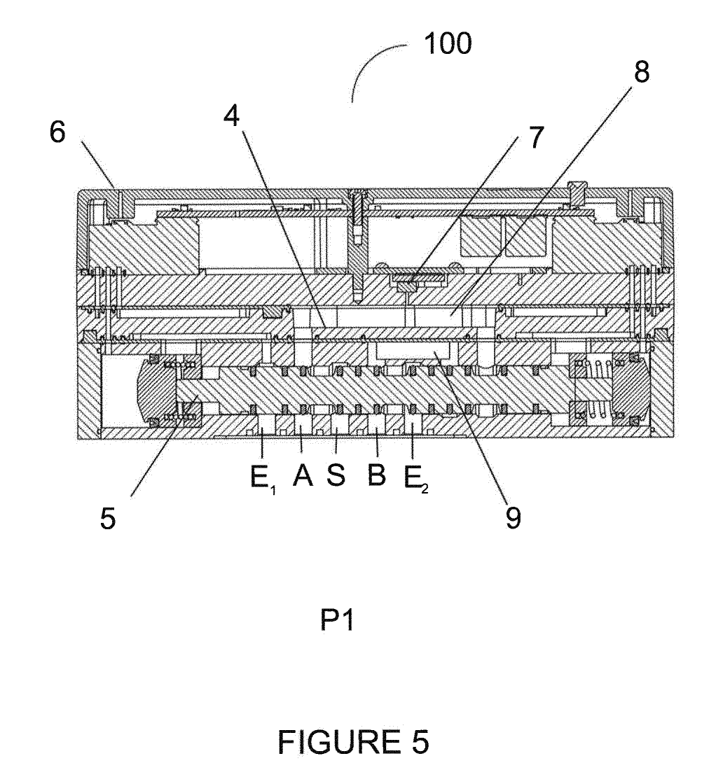

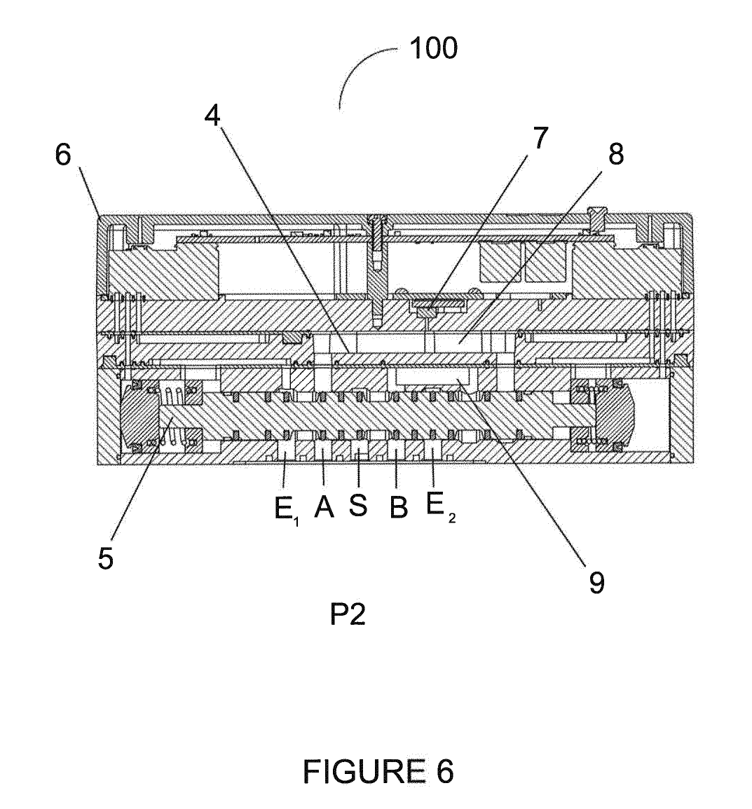

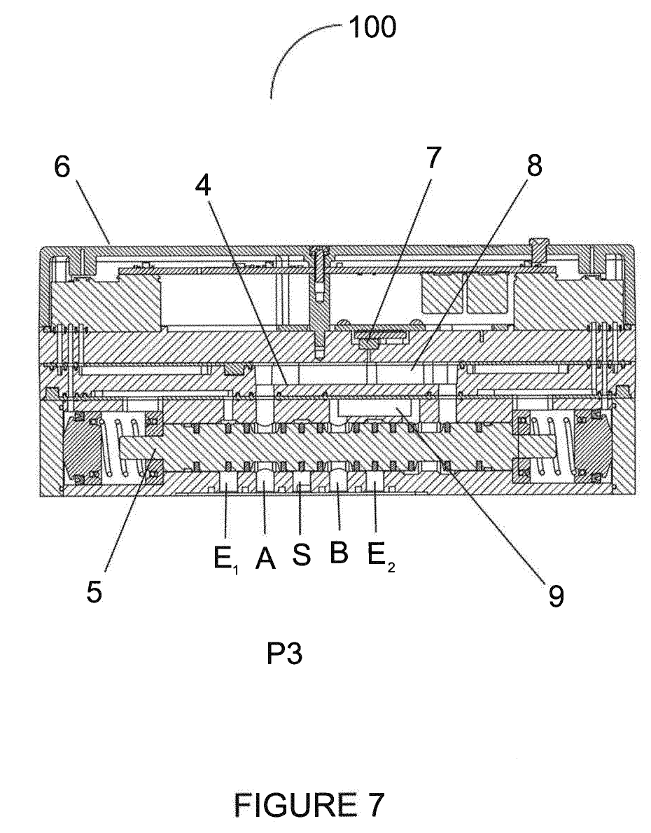

A design embodiment of leak-detecting directional control valve 100 is shown in cross section in FIGS. 5 through 7. Specifically, FIGS. 5 through 7 depict the three respective spool positions (a/k/a valve positions) corresponding to the design variation depicted schematically in FIG. 3. FIG. 5 shows spool 5 in the first position P1 in FIG. 3, which provides port connectivity between ports S and A, and between ports E2 and B, respectively. FIG. 6 shows spool 5 in the second position (P2 in FIG. 3), which provides port connectivity between ports E1 and A, and between ports S and B, respectively. FIG. 7 shows spool 5 in the third (i.e., equilibration) position (P3 in FIG. 3), which provides exclusive fluid communication between ports A and B (via intra-valve flow segments 8 and 9) and fluid isolation of the S and E ports. Note that spool position P3 is physically in between spool positions P1 and P2. Note also that in this embodiment pressure sensor 7 is located within valve 100, such that it measures the pressure in the isolated fluid subsystem within intra-valve flow path 4 when valve 100 is placed in the third position P3 (specifically, in the design embodiment as drawn, it measures the pressure in flow path 8 between ports A and B). As in the schematic shown in FIG. 3, pressure sensor 7 in the design embodiment shown measures the pressure at port A when in either spool position P1 or P2.

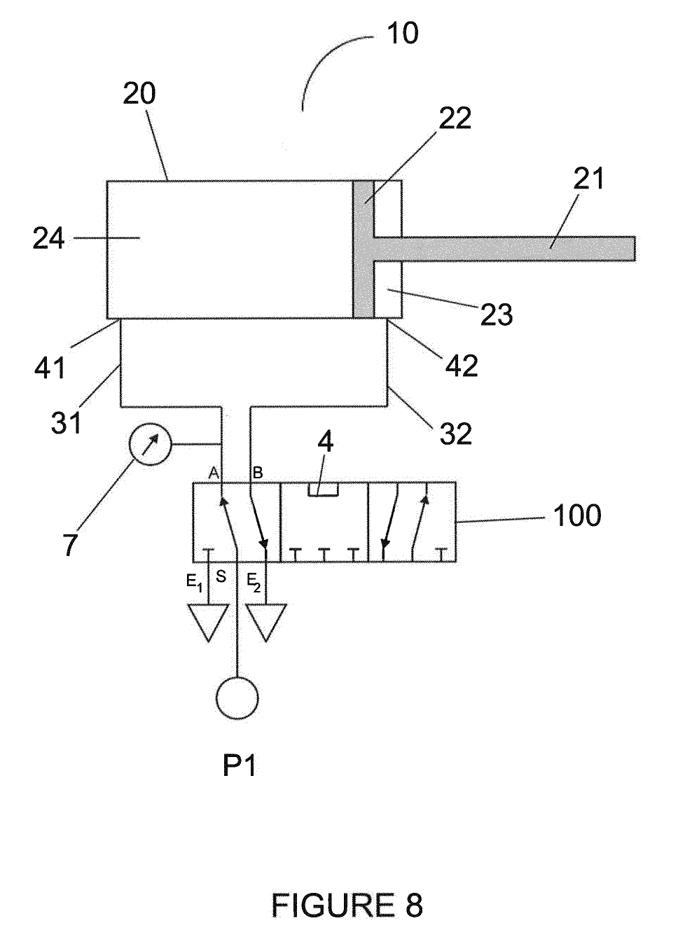

FIGS. 8 through 11 depict valve 100 as part of a fluid subsystem 50 (of overall fluid system 10) that includes a double-acting cylinder (actuator) 20. Actuator 20 includes a first component chamber 24 and a second component chamber 23. Port 41 fluidly connects chamber 24 to fluid connection 31 leading to first outlet port A of valve 100. Port 42 fluidly connects chamber 23 to fluid connection 32 leading to second outlet port B of valve 100. In depicted embodiment system 10, the fluid subsystem 50 becomes an isolated fluid subsystem when valve 100 of fluid system 10 is in the third-position P3 (i.e., the equilibrium configuration). This position P3 can be utilized to detect potential leakage from isolated fluid subsystem 50 to the environment. Specifically, in circumstances during which the pneumatic actuation system 10 is transitioning between a first actuator position (e.g., position P1 with rod 21 extended) and a second actuator position (e.g., position P2 with rod 21 retracted), directional control valve 100 can briefly employ the equilibrium configuration P3, which allows compressed air (or similar gas) to flow from the previously pressurized chamber 24 of actuator 20 to the previously depressurized chamber 23 on the other side of piston 22. Once this mass flow transient has completed, the pressure throughout the entire isolated fluid subsystem 50 should remain essentially constant. If, however, the pressure decays following the initial pressure equilibration, one can infer that the pressure decay indicates a loss of fluid mass (i.e., a leak) from isolated subsystem 50 to the environment. As such, a method can detect leakage from isolated fluid subsystem 50 into the environment by measuring a single pressure within isolated fluid subsystem 50 (most preferably by measuring the pressure inside intra-valve flow path 4 located inside the directional control valve 100), while valve 100 is in the equilibrium configuration (i.e., the third position P3). The method does not substantially interrupt the normal operation of the pneumatic actuator, because the third position in which the leak is detected is employed only briefly between configuring the valve (and actuator) between the first and second valve and actuator positions. As such, a leak can be detected with minimal additional apparatus (i.e., a single pressure sensor embedded in the valve); without substantially altering the normal operation of the pneumatic system; and is easily employed during every cycle in which the actuator is moved between the first and second actuator positions, such that the leak detection occurs repeatedly and frequently.

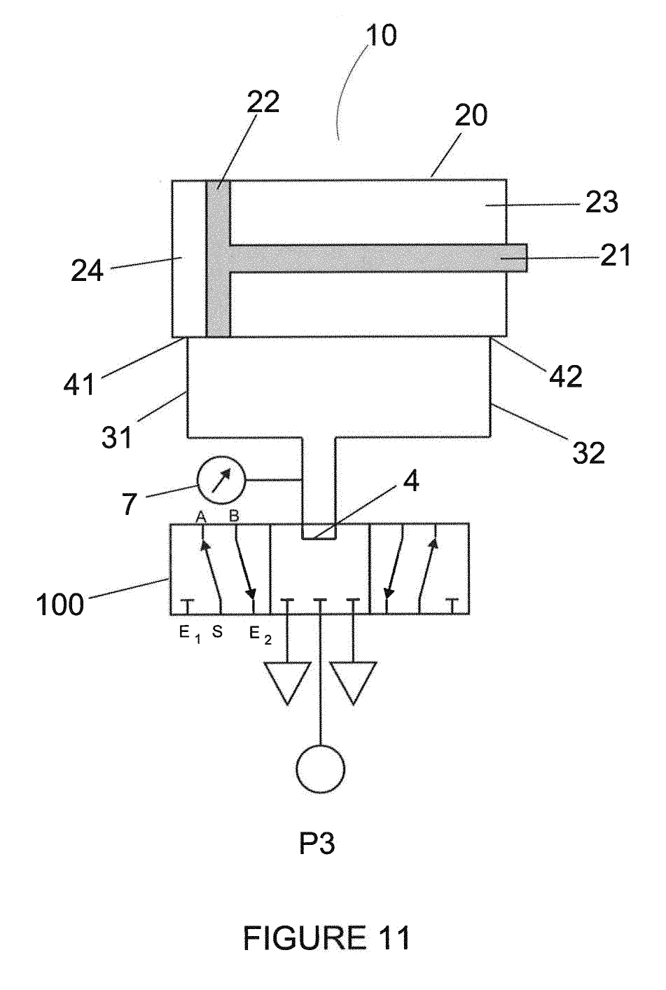

The sequence of actions corresponding to a preferred leak detection method is shown in FIGS. 8 through 11. This sequence of actions can be described as follows. Actuator 20 is initially configured into the first actuator position by configuring valve 100 into the first valve position (also known as first spool position) P1. Specifically, configuring valve 100 in the first valve position pressurizes a first side (chamber 24) of actuator 20 and exhausts a second side (chamber 23), which configures actuator 20 to a first actuator position with rod 21 extended as depicted in FIG. 8. Actuator 20 is configured into a second actuator position with rod 21 retracted as depicted in FIG. 11 by configuring valve 100 into the second valve position P2. In particular, configuring valve 100 in the second valve position P2 pressurizes the chamber 23 of actuator 20 and exhausts chamber 24, which configures actuator 20 into the second actuator position with rod 21 retracted as depicted in FIG. 11. FIG. 8 shows valve 100 configured in the first position, and actuator 20 correspondingly also configured in the first actuator position (shown in this example as the fully extended position). Note that pressure sensor 7 is depicted in FIG. 8 at the first outlet port A, although the single pressure sensor 7 could have alternatively been depicted at the second outlet port B. As FIGS. 8 through 11 are schematic depictions of a pneumatic system, the placement of sensor 7 on the line representing the fluid connection 31 between valve 100 and first chamber 24 of actuator 20 is not meant to indicate that sensor 7 is not contained within valve 100. Although the pressure sensor could be located outside the valve, as noted above, a preferred embodiment of valve 100 includes the sensor 7 within the valve structure 6, particularly within the intra-valve flow path 4, or more specifically within intra-valve pathway segments 8 and/or 9 between ports A and B.

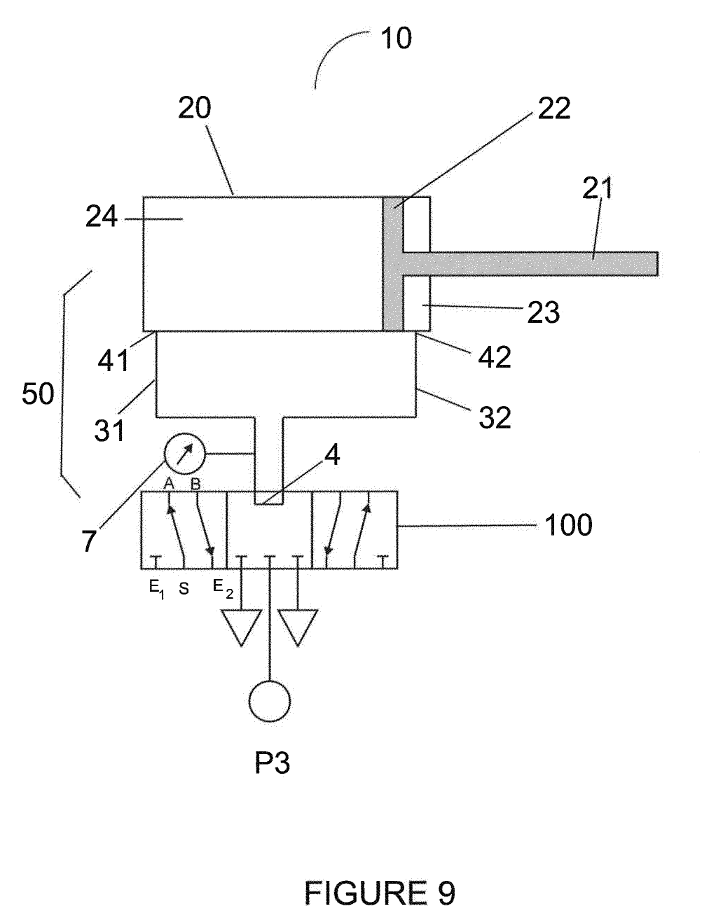

When switching actuator 20 from the first actuator position to the second actuator position, rather than configuring valve 100 directly into the second valve position, valve 100 is instead configured briefly into the third valve position (i.e., the equilibrium configuration), as shown schematically in FIG. 9. When valve 100 is configured into the third valve position, isolated fluid subsystem 50 is created. Isolated fluid subsystem 50 comprises a first component chamber 24, a second component chamber 23, fluid connection 31, fluid connection 32 and intra-valve flow paths 8 and 9. When valve 100 is configured into the third valve position, isolated fluid subsystem 50 first undergoes a rapid flow transient, in which pressurized gas from the previously pressurized chamber 24 of actuator 20 flows rapidly to the previously depressurized chamber 23 of actuator 20. During this time, the pressure in isolated fluid subsystem 50 rapidly changes. For the case depicted, because pressure sensor 7 was fully pressurized in FIG. 8, the pressure measured by the single pressure sensor 7 will rapidly decay during the initial flow transient, until the pressure in both component chambers 23, 24 of actuator 20 have equilibrated at some intermediate pressure between the supply pressure and exhaust pressure. Following this rapid equilibration event, the pressure is expected to reach an equilibrium pressure for the remainder of time valve 100 is configured in the P3 equilibrium configuration. During this equilibrium phase, assuming no mass leaves isolated subsystem 50 (i.e., assuming no leakage), the measured pressure at pressure sensor 7 is expected to remain essentially constant (i.e., the pressure should remain essentially constant in the absence of fluid leaks). If, conversely, fluid mass is leaving fluid subsystem 50 due to leakage, the pressure in isolated fluid subsystem 50 (as measured by pressure sensing element 7) should decay at a rate proportional to the rate of fluid leakage (i.e., proportional to the rate at which mass is leaving the system. As such, pressure measurement during this equilibrium phase can indicate a leak within the isolated fluid subsystem 50 (i.e., a leak within actuator 20, actuator supply lines 31, 32, actuator ports 41, 42, outlet ports A, B of the valve, or intra-valve flow path 4). The brief nature of the pressure transient during the period of time valve 100 is configured in the third position is sufficiently rapid to allow the system to reach pressure equilibrium such that pressure sensing element 7 can be employed to detect a leak in isolated fluid subsystem 50 during the brief period of time valve 100 is configured in the third position P3. This brief period of time that valve 100 is configured in the third position is referred to here as the “dwell period.”

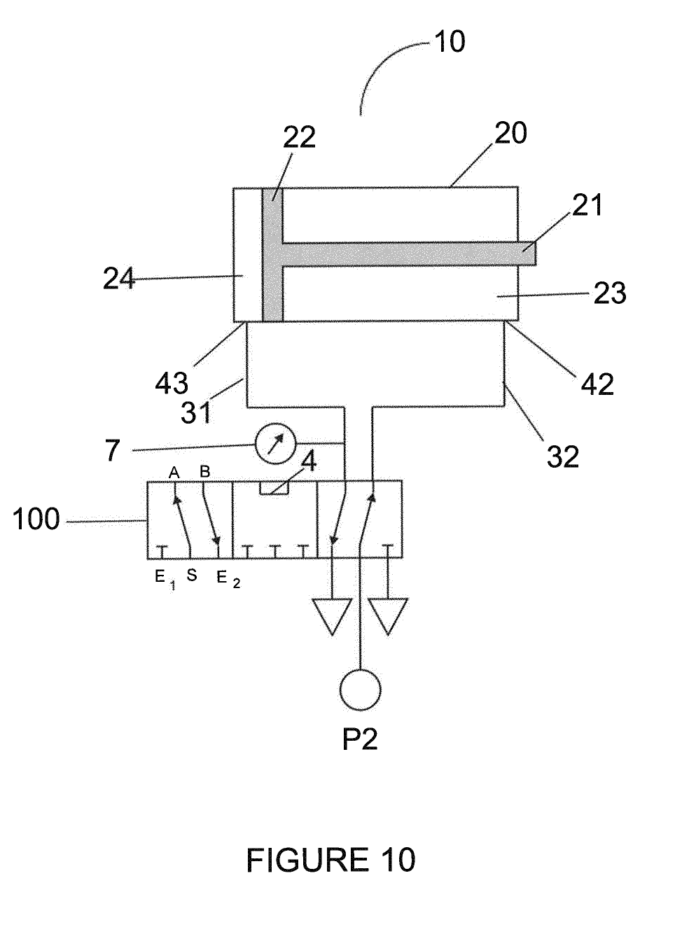

Following the dwell period, valve 100 is configured in the second valve position P2, which subsequently configures actuator 20 into the second actuator configuration, as depicted in FIG. 10 (which in this example is the fully retracted position). The third-position dwell period, and corresponding leak detection procedure, can again be employed when reconfiguring the system from the second position to the first position, as shown in FIG. 11. Note that the leak detection method can either employ a dwell when configuring the valve from the first to the second position (i.e., FIG. 9), a dwell when configuring the valve from the second to the first position (i.e., FIG. 11), or both. Note also that the method enables leak detection without knowledge of system parameters, such as total volume or supply pressure, and enables leak detection with a single pressure sensor. In a preferred embodiment, pressure sensor 7 is located in the equilibrium flow channel 8, equilibrium flow channel 9, or both channels, within directional control valve 100, as indicated in the two embodiment schematics shown in FIGS. 3 and 4.

When in the third position P3 for the dwell period, the essential procedure for leak detection can proceed as follows. Upon configuring valve 100 into the third position, valve 100 is maintained in the third position for a period of time determined sufficient to allow for the equilibration pressure transient to conclude, plus a period of time determined sufficient to allow sufficient measurement sensitivity for leak detection. In a typical subsystem like that depicted, the equilibration event could reasonably have a duration on the order of 100 ms, but this duration of dwell will depend on various system parameters (e.g. volume of fluid channels within a given system) and can be adjusted accordingly. For purposes of explanation, the dwell period will be assumed as 100 ms, but this example is not meant to be limiting. Following the equilibration transient (e.g., after approximately 100 ms), the isolated subsystem will enter a nominal equilibrium state. The pressure can then be measured for a selected period of time (in this example, again, on the order of 100 ms would be reasonable) while the system is in the nominal equilibrium state. Based upon the measured pressure during this equilibrium state period, the average rate of change of pressure in the isolated subsystem can be calculated. If the rate of change of pressure (i.e., the pressure decay rate) exceeds an acceptable threshold, then a leak is indicated. The magnitude of the leak will be related to the magnitude of pressure decay rate.

In a preferred embodiment, pressure sensor 7 will output an electric signal based upon the fluid pressure impacting sensor 7. Sensor 7 is in electrical communication with a processor (not shown) that processes the output signals into values that can be recorded and compared against values deemed to represent acceptable pressure levels or changes. In a preferred embodiment, the processor is the same one or part of the same controlling unit that controls the valve, such that it has knowledge of both the pressure measurement and valve position. The existence and extent of the leak can be reported by the leak detection system in various ways, including via an indicator light (e.g., on the valve or manifold), or by transmitting data via a wired or wireless connection to a remote data node or terminal. Note that a leakage detection algorithm can be employed to combine leakage detection over multiple actuator switching cycles in order to increase the confidence of leak detection. The system can include a controller (not shown) in communication with the processor and the valve that can control switching of valve positions. In one embodiment, the controller can control valve switching based upon measured pressure or pressure decay.

Note that this method is enabled by the intermittent existence of the isolated subsystem 50, which exists only during the period of time in which valve 100 is held in the equilibrium configuration P3. In the absence of the equilibrium configuration (and corresponding isolated subsystem 50), leak detection would become substantially more complex, and would require for example, measurement of mass flow into valve 100, measurement of mass flow out of valve 100, and accounting for the compressed air mass within valve 100 (which will generally require several additional components and measurements). Measurement of mass flow is considerably more complex than measurement of pressure. Hence, by creating an isolated subsystem 50, the present inventive method provides for a more simplified leak detection method.

In addition to detecting a leak, the pressure measurement using pressure sensor 7 can be used to determine the period of time valve 100 should be held in the equilibration configuration P3 when switching between the two standard valve configurations P1 and P2. While in the equilibration configuration P3, the compressed air will initially flow from the pressurized side to the depressurized side, until the pressure throughout isolated subsystem 50 has equilibrated. In order to maintain a favorable speed of response from the first position of actuator 20 to the second, the time spent in the equilibration configuration beyond equilibration of pressure should be minimized. As such, in one embodiment, pressure can be measured in the equilibration flow channels 8 and/or 9 within valve 100, and the rate of change in pressure can be used to determine how long valve 100 should spend in the equilibration configuration. For example, in one embodiment, when switching between the first and second positions of actuator 20, the processor and controller can maintain valve 100 in the equilibration configuration until the rate of change of pressure in isolated subsystem 50 falls below a predetermined threshold.

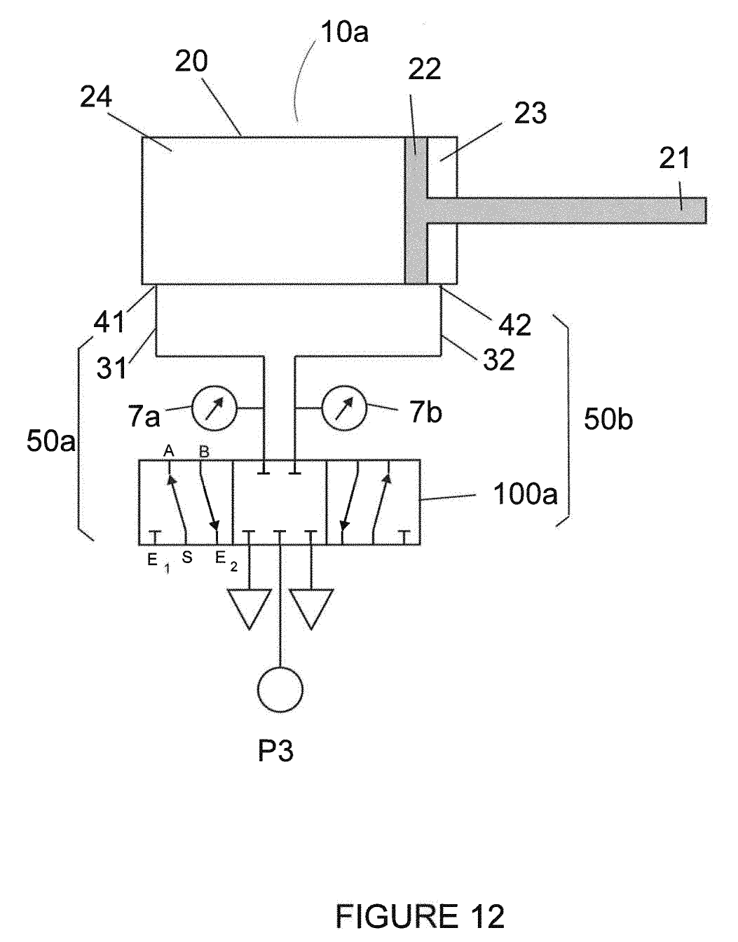

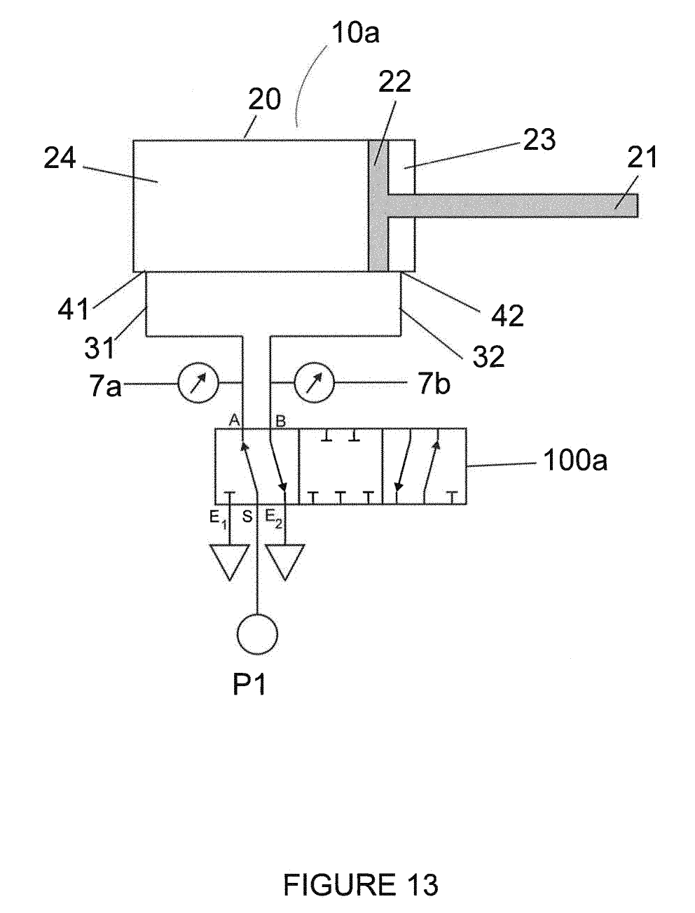

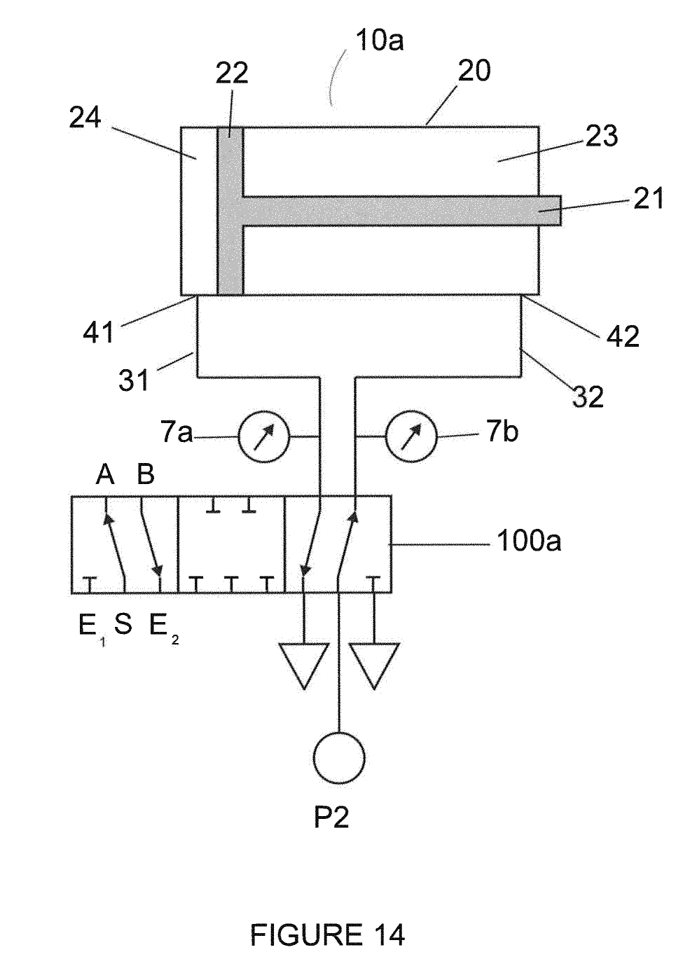

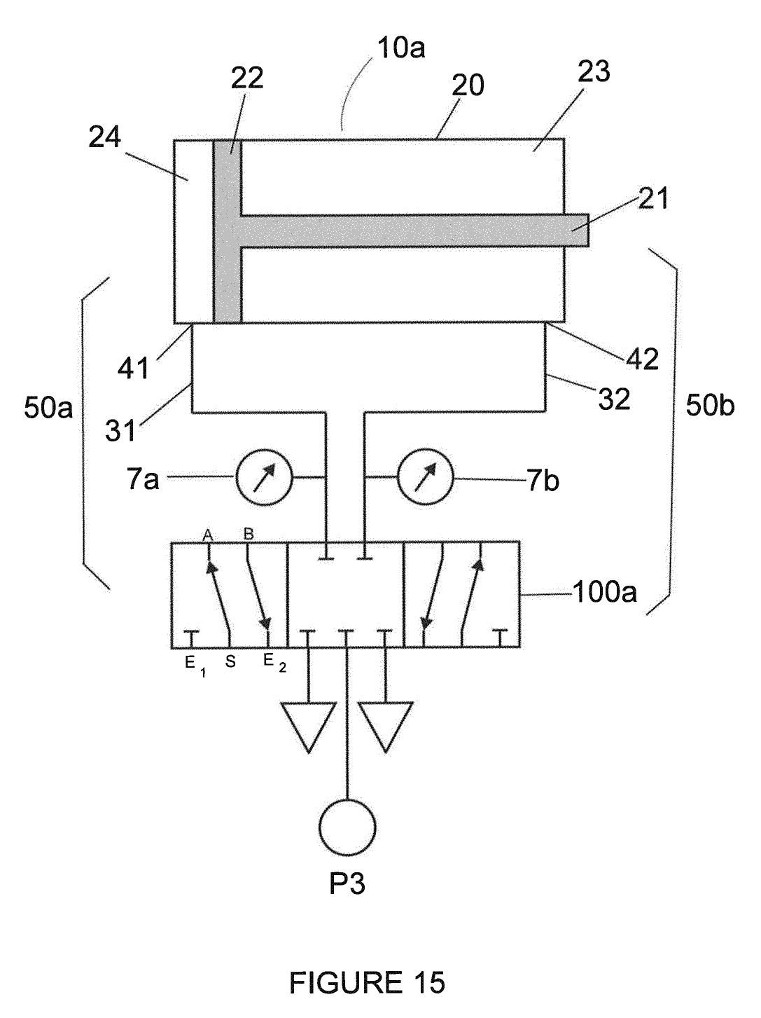

In another embodiment, rather than the single isolated subsystem 50 created by the equilibrium configuration shown in FIG. 2A, a directional control valve 1c with an all-ports-blocked (APB) port connectivity configuration (an APB valve) can be employed. This valve schematic is shown in FIG. 2B and the corresponding valve system 10a is shown in FIGS. 12 through 15. In the first and second valve positions, the APB valve 100a provides standard directional-control valve port connectivity, while in the third position, the APB valve 100a maintains all outlet ports in fluid isolation. Unlike the valve described by FIG. 2A and FIGS. 3 through 7, the physical design of a valve that provides APB port connectivity is known in the existing art. Such valves, however, are not typically employed with pressure sensing to temporarily or intermittently create isolated fluid subsystems that enable the leak detecting method disclosed here. Specifically, as depicted in FIGS. 13 and 14, when the APB valve 100a is configured in the first or second valve positions, P1 or P2 respectively, the standard port connectivity configures the actuator into the first or second actuator positions, respectively, as depicted in FIGS. 13 and 14, As shown in FIGS. 12 and 15, when the APB valve 100a is configured in the third valve position P3, the third-position connectivity configuration will create two isolated subsystems 50a, 50b, wherein subsystem 50a comprises the first chamber 24 of actuator 20 and the associated actuator supply line 31 communicating with first outlet port A, and wherein subsystem 50b comprises the second chamber 23 of actuator 20 and supply line 32 communicating with second outlet port B. If in a preferred embodiment each of the respective isolated subsystems 50a and 50b include at least one pressure sensor, the third valve position can be employed briefly when configuring the valve (and actuator) between the first and second valve (and actuator) positions to create a pair of temporary isolated fluid subsystems. Like in the valve of FIG. 2A, the isolated fluid subsystems 50a and 50b enable detection of fluid mass loss via fluid pressure loss (assuming isothermal conditions). Specifically, if valve 100a is placed in the third position when transitioning between the first and second actuator positions, as shown in FIGS. 13 and 15, pressure measurement in the respective isolated subsystem 50a or 50b that was previously pressurized can be used to detect leakage out of the respective isolated subsystems 50a or 50b, in the same manner previously described (e.g., based on pressure decay). Further, pressure measurement in the isolated subsystem previously depressurized can be used to detect leakage across the actuator piston 22 (as opposed to leakage from the isolated subsystem to the environment). When employing this configuration, the presence of a leak can be localized as existing on either the first or second sides of actuator 20 (i.e., the leak can be localized as either being in subsystem 50a or 50b). Unlike the valve of FIG. 2A, the APB valve 100a does not entail an equilibration transient in the third position. As such, rather the isolated fluid subsystems 50a and 50b exhibit an initial rapid pressure change followed by a nominal equilibrium period, the system behavior in the respective isolated fluid subsystems in the absence of a leak would be an immediate fluid equilibrium. As such, any rate of pressure decay (beyond some predetermined threshold) in a previously pressurized side of the actuator while in the third valve position would indicate a loss of fluid (i.e., would indicate a leak). Further, any rate of pressure increase in a previously depressurized side of the actuator while in the third valve position would indicate a leak across the actuator piston from the pressurized side of the actuator into the depressurized side. As in the previously described method, once the valve 100a dwells in the third position P3 for a period of time sufficient to detect such leakage, the valve would then be configured to the respective desired standard first or second position. Although FIGS. 12-15 illustrate the method on a double-acting cylinder, the method could also be employed using only of the two outlet ports, such as when used with a single-acting cylinder or a single component chamber.

While exemplary embodiments are described herein, it will be understood that various modifications to the system methods and apparatus can be made without departing from the scope of the present invention.

What is claimed is:

1. A method for detecting leaks in a pneumatic system comprising: a) a directional control valve comprising a supply port, one or more exhaust ports, a first valve outlet port, and a second valve outlet port; b) a first component chamber fluidly connected to a first component port and a second component chamber fluidly connected to a second component port; and c) the first component port being fluidly connected to the first valve outlet port and the second component port being fluidly connected to the second valve outlet port, the method comprising:
A. configuring the valve such that the valve establishes an exclusive intra-valve fluid flow path between the first and second valve outlet ports and establishes respective isolation of the supply port and the one more exhaust ports and thereby creates an isolated fluid subsystem that includes:
the first component chamber;
the second component chamber;
the fluid connection between the first component port and the first valve outlet port;
the fluid connection between the second component port and the second valve outlet port; and
the intra-valve flow path between the first and second valve outlet ports;
B. sensing the pressure within the isolated fluid system; and
C. comparing the sensed pressure to a value determined to represent an acceptable system pressure for the isolated fluid system.

2. The method of claim 1, wherein the valve is sequentially configured into the configuration of step A:
a. directly after the valve is placed in a first configuration in which the valve establishes an exclusive fluid connection of the supply port with the first valve outlet port and a simultaneous exclusive fluid connection of one of the one or more exhaust ports with the second valve outlet port and directly before the valve is placed in a second configuration in which the valve establishes an exclusive fluid connection of the supply port with the second valve outlet port, and a simultaneous exclusive fluid connection of one of the one or more exhaust ports with the first valve outlet port; or b. directly after the valve is placed in the second configuration and directly before the valve is placed in the first configuration.

3. The method of claim 2, wherein the sensing of pressure is performed after a period of time that allows for the equilibration of pressures at the first component port and the second component port.

4. The method of claim 2, wherein the value determined to represent an acceptable system pressure is determined based upon a measurement of pressure in the pneumatic system while the valve is in the first or second configurations.

5. The method of claim 1 wherein the sensing of pressure is performed by a pressure sensor located in the intra-valve fluid flow path between the first and second valve outlet ports.

6. A method for detecting leaks in a pneumatic system comprising: a) a directional control valve comprising a supply port, one or more exhaust ports, a first valve outlet port, and a second valve outlet port; b) a first component chamber fluidly connected to a first component port and a second component chamber fluidly connected to a second component port; and c) the first component port being fluidly connected to the first valve outlet port and the second component port being fluidly connected to the second valve outlet port, the method comprising:
A. configuring the valve such that the valve establishes an exclusive intra-valve fluid flow path between the first and second valve outlet ports and establishes respective isolation of the first and second valve inlet ports and thereby creates an isolated fluid subsystem that includes:
the first component chamber;
the second component chamber;
the fluid connection between the first component port and the first valve outlet port;
the fluid connection between the second component port and the second valve outlet port; and
the intra-valve flow path between the first and second valve outlet ports;
B. sensing the pressure within the isolated fluid subsystem for a plurality of time intervals during the time the valve is in the configuration that creates the isolated fluid subsystem; and
C. comparing the sensed pressures associated with one or more time intervals to determine a rate of pressure change in the isolated fluid subsystem and comparing the determined rate of pressure change to a value representing an acceptable level of pressure decay for the isolated fluid subsystem.

7. The method of claim 6 wherein the sensing of pressure is performed by a pressure sensor located in the intra-valve fluid flow path between the first and second valve outlet ports.

8. The method of claim 6, wherein the valve is sequentially configured into the configuration of step A of claim 6:
a. directly after the valve is placed in a first configuration in which the valve establishes an exclusive fluid connection of the supply port with the first valve outlet port and a simultaneous exclusive fluid connection of one of the one or more exhaust ports with the second valve outlet port and directly before the valve is placed in a second configuration in which the valve establishes an exclusive fluid connection of the supply port with the second valve outlet port, and a simultaneous exclusive fluid connection of one of the one or more exhaust ports with the first valve outlet port; or
b. directly after the valve is placed in the second configuration and directly before the valve is placed in the first configuration.

9. The method of claim 6, wherein if the determined rate of pressure change in the isolated fluid subsystem is above a certain value, maintaining the valve in the configuration until the rate of pressure of pressure change in the isolated fluid system falls below a specified value.

10. A method for detecting leaks in a pneumatic system comprising: a) a directional control valve comprising a supply port, one or more exhaust ports, a first valve outlet port, and a second valve outlet port; b) a first component chamber fluidly connected to a first component port and a second component chamber fluidly connected to a second component port; and c) the first component port being fluidly connected to the first valve outlet port and the second component port being fluidly connected to the second valve outlet port, the method comprising:
configuring the valve such that the valve establishes the fluid isolation of the supply port, the one or more exhaust ports, the first valve outlet port and the second valve outlet port from each other and thereby creating:
a first isolated fluid subsystem comprising:
the first component chamber and the fluid connection between the first component port and the first valve outlet port; and
a second isolated fluid subsystem comprising:
the second component chamber and the fluid connection between the second component port and the second valve outlet port;
B. sensing the fluid pressure within at least one of the first and second isolated fluid subsystems; and
C. then performing one or more of the following comparisons:
i) if fluid pressure was sensed from the first isolated fluid subsystem, comparing the sensed pressure to a value determined to represent an acceptable system pressure for the first isolated fluid subsystem; or
ii) if fluid pressure was sensed from the second isolated fluid subsystem, comparing the sensed pressure to a value determined to represent an acceptable system pressure for the second isolated fluid subsystem.

11. The method of claim 10 wherein the sensing of pressure is performed by a pressure sensor located in the directional control valve.

12. The method of claim 10, wherein the valve is sequentially configured into the configuration of step A of claim 10:
a. directly after the valve is placed in a first configuration in which the valve establishes an exclusive fluid connection of the supply port with the first valve outlet port and a simultaneous exclusive fluid connection of one of the one or more exhaust ports with the second valve outlet port and directly before the valve is placed in a second configuration in which the valve establishes an exclusive fluid connection of the supply port with the second valve outlet port, and a simultaneous exclusive fluid connection of one of the one or more exhaust ports with the first valve outlet port; or
b. directly after the valve is placed in the second configuration and directly before the valve is placed in the first configuration.

13. The method of claim 12 wherein the value determined to represent an acceptable system pressure is determined based upon a measurement of pressure in the pneumatic system while the valve is in the first or second configurations.

14. A method for detecting leaks in a pneumatic system comprising: a) a directional control valve comprising a supply port, one or more exhaust ports, a first valve outlet port, and a second valve outlet port; b) a first component chamber fluidly connected to a first component port and a second component chamber fluidly connected to a second component port; and c) the first component port being fluidly connected to the first valve outlet port and the second component port being fluidly connected to the second valve outlet port, the method comprising:
A. configuring the valve such that the valve establishes the fluid isolation of the supply port, the one or more exhaust ports, the first valve outlet port and the second valve outlet port from each other and thereby creating:
a first isolated fluid subsystem comprising:
the first component chamber and the fluid connection between the first component port and the first valve outlet port; and
a second isolated fluid system comprising:
the second component chamber and the fluid connection between the second component port and the second valve outlet port;
B. sensing the fluid pressure within at least one of the first and second isolated fluid subsystems for a plurality of time intervals during the time the valve is in the configuration that creates the first and second isolated fluid subsystems; and
C. comparing the sensed pressures associated with one or more time intervals to determine a rate of pressure change in the at least one isolated fluid subsystem and comparing the determined rate of pressure change to a value representing an acceptable level of pressure decay for the at least one isolated fluid subsystem.

15. The method of claim 14 wherein the sensing of pressure is performed by a pressure sensor located in the directional control valve.

16. The method of claim 14, wherein the valve is sequentially configured into the configuration of step A of claim 14:
a. directly after the valve is placed in a first configuration in which the valve establishes an exclusive fluid connection of the supply port with the first valve outlet port and a simultaneous exclusive fluid connection of one of the one or more exhaust ports with the second valve outlet port and directly before the valve is placed in a second configuration in which the valve establishes an exclusive fluid connection of the supply port with the second valve outlet port, and a simultaneous exclusive fluid connection of one of the one or more exhaust ports with the first valve outlet port; or
b. directly after the valve is placed in the second configuration and directly before the valve is placed in the first configuration.

17. A pneumatic system comprising:
a directional control valve and at least one pneumatic component;
the directional control valve including a supply port, one or more exhaust ports, a first valve outlet port, and a second valve outlet port;
the supply port connecting to a fluid supply and the one or more exhaust ports connecting to exhaust;
the at least one pneumatic component including a first component port in fluid communication with a first component chamber and a second component port in fluid communication with a second component chamber;
a fluid connection connecting the first valve outlet port with the first component port and a fluid connection connecting the second valve outlet port to the second component port, and
the directional control valve capable of being configured into a first configuration, a second configuration and a third configuration whereby:
a. in the first configuration the valve establishes an exclusive fluid connection of the supply port with the first valve outlet port, and the simultaneous exclusive fluid connection of one of the one or more exhaust ports with the second valve outlet port;
b. in the second configuration the valve establishes an exclusive fluid connection of the supply port with the second valve outlet port, and the simultaneous exclusive fluid connection of one of the one or more exhaust ports with the first valve outlet port; and
c. in the third configuration the valve establishes an exclusive intra-valve fluid flow path between the first and second valve outlet ports and establishes respective isolation of the first valve inlet port and the second valve inlet port, such that the valve creates an isolated fluid subsystem that includes:
the first component chamber;
the second component chamber;
the fluid connection between the first component port and the first valve outlet port;
the fluid connection between the second component port and the second valve outlet port; and
the intra-valve flow path between the first and second valve outlet ports; and
at least one pressure sensor configured to measure pressure within the isolated fluid subsystem established by the third configuration of the valve.

18. The system of claim 17 wherein the at least one pressure sensor is located within the intra-valve fluid flow path between the first and second valve outlet ports.

19. The system of claim 17 wherein the at least one pressure sensor outputs a signal that varies based upon the sensed pressure and the system further includes a processor in electrical communication with the sensor and that is configured to process the signal output by the sensor and determine if any leakage exists in the isolated fluid subsystem the third configuration.

20. The system of claim 19 further including an indicating device in wired or wireless electrical communication with the processor, the processor being configured to activate the indicating device based upon a determination of leakage by the processor.

21. The system of claim 19 wherein the at least one pressure sensor is configured to obtain and transmit to the processor a plurality of pressure readings in the isolated fluid system after a time period that allows for the equilibration of pressures at the first component port and the second component port and the pressure sensor, and the processor is configured to process the plurality of pressure readings from the sensor to determine a rate of pressure decay in the isolated fluid system of the third configuration.

22. The valve of claim 21 further including an indicating device in wired or wireless electrical communication with the processor, the processor being configured to activate the indicating device based upon a sensed rate of pressure decay in the isolated fluid subsystem.

23. The system of claim 21 wherein the processor is further configured to compare the determined rate of pressure decay against a rate of decay deemed minimally acceptable.

24. The system of claim 23 wherein the processor is part of or in electrical communication with a controller, the controller being configured to maintain the valve in the third configuration for a predetermined period of time.

25. A pneumatic directional control valve comprising:
a valve body housing a fluid diverter, the valve body comprising a supply port, one or more exhaust ports, a second valve outlet port and second valve inlet port;
the fluid diverter of the pneumatic directional control valve capable of being configured into a first configuration, a second configuration and a third configuration whereby:
a. in the first configuration the fluid diverter establishes an exclusive fluid connection of the supply port with the first valve outlet port and the simultaneous exclusive fluid connection of one of the one or more exhaust ports with the second valve inlet port;
b. in the second configuration the fluid diverter establishes the exclusive fluid connection of the supply port with the second valve outlet port and the simultaneous exclusive fluid connection of one of the one or more exhaust ports with the first valve outlet port; and
c. in the third configuration the fluid diverter establishes an exclusive intra-valve fluid flow path between the first and second valve outlet ports and establishes respective isolation of the supply port and the one or more exhaust ports; and
at least one pressure sensor disposed within the valve body and configured to measure pressure of a fluid within the exclusive intra-valve fluid flow path between the first and second valve outlet ports established by the third valve configuration.

26. The valve of claim 25 wherein the at least one pressure sensor is located within the intra-valve fluid flow path between the first and second valve outlet ports.

27. The valve of claim 26 wherein the pressure sensor is configured to output a signal that varies based upon the sensed pressure and the valve further includes a processor in electrical communication with the sensor and that is configured to receive the signal output by the sensor and process it so as to compare a pressure sensed by the sensor to a pressure value deemed acceptable for the isolated fluid subsystem comprising the intra-valve fluid flow path.

28. The valve of claim 26 wherein the pressure sensor is configured to output a signal that varies based upon the sensed pressure and the valve further includes a processor in electrical communication with the sensor and that is configured to receive signal outputs by the sensor over time and process the signal outputs so as to compare pressures sensed by the sensor over one or more time intervals to calculate a rate of pressure decay for the isolated fluid subsystem and compare that calculated rate of decay to a rate of decay deemed acceptable for the isolated fluid subsystem.

29. The valve of claim 27 further including an indicating device in wired or wireless electrical communication with the processor, the processor being configured to activate the indicating device based upon a pressure level sensed by the sensor.

30. The valve of claim 28 further including an indicating device in wired or wireless electrical communication with the processor, the processor being configured to activate the indicating device based upon a sensed rate of pressure decay in the isolated fluid subsystem,

31. The valve of claim 25 wherein the position of the fluid diverter when the valve is in the third configuration is in between the position of the fluid diverter when the valve is in the first configuration and the second configuration.
